(19) United States
(12) Patent Application Publication
(10) Pub. No.: US 2025/0147721 A1
(43) Pub. Date: May 8, 2025

(54) VOICE CONTROL METHOD AND ELECTRONIC DEVICE

(71) Applicant: ASUS GLOBAL PTE. LTD., SINGAPORE (SG)

(72) Inventors: Peipei Chen, SINGAPORE (SG); Ping Yuan, SINGAPORE (SG)

(73) Assignee: ASUS GLOBAL PTE. LTD., SINGAPORE (SG)

(21) Appl. No.: 18/900,920

(22) Filed: Sep. 30, 2024

(30) Foreign Application Priority Data
Nov. 3, 2023 (CN) 202311459847.1

(51) Int. Cl. G06F 3/16; G06F 3/0488; G10L 15/22

(52) U.S. Cl. CPC G06F 3/167; G06F 3/0488; G10L 15/22; G10L 2015/223

(57) ABSTRACT

A voice control method and an electronic device are provided. The method is adapted to the electronic device including a touch screen and a voice input device and includes the following steps. Historical touch data of a plurality of historical touch operations performed on a user interface is recorded. A plurality of habitual touch areas on the user interface are determined according to the historical touch data of the user interface. Multiple area markers of the habitual touch areas are displayed on the user interface when the user interface is displayed through a touch screen. A voice command is received through the voice input device. An input operation is determined according to a first area marker in the voice command, and the input operation is performed on the user interface.

### CROSS-REFERENCE TO RELATED APPLICATION

This application claims the priority benefit of China application serial no. 202311459847.1, filed on Nov. 3, 2023. The entirety of the above-mentioned patent application is hereby incorporated by reference herein and made a part of this specification.

### BACKGROUND

### Technical Field

The disclosure relates to a voice control method and an electronic device.

### Description of Related Art

In nowadays society, modern people are increasingly dependent on consumer electronic devices. In order to achieve the purpose of being convenient, being light and thin, and being user-friendly, many products have changed from traditional keyboards or cursors to using touch screens as input devices. In recent years, touch-sensitive electronic products are loved by consumers due to the convenient operation and high intuitiveness thereof and have gradually become a mainstream trend in the market. As touch electronic products have more and more functions, the touch operation method of simply touching the screen directly can no longer meet the operational needs of users. Alternatively, in some operation situations, the user just cannot touch the touch screen with the hand or other touch objects, so it is difficult to issue control commands to the touch electronic products. Currently, although voice control functions have gradually been widely equipped on some electronic products, generally, the voice functions merely support predefined and quite limited operations hence cannot allow users to control the devices through voice as the users wish.

### SUMMARY

The disclosure relates to a voice control method and an electronic device, which can be used to solve the above technical problems.

An embodiment of the disclosure provides a voice control method, which is adapted to an electronic device including a touch screen and a voice input device. The method includes the following steps. Historical touch data for multiple historical touch operations performed on the user interface is recorded. Multiple habitual touch areas on the user interface based on the historical touch data of the user interface is determined. When the user interface is displayed through the touch screen, multiple area markers of multiple habitual touch areas are displayed on the user interface. A voice command is received through the voice input device. An input operation is determined based on a first area marker in the voice command, and the input operation is performed on the user interface.

An embodiment of the disclosure provides an electronic device, which includes a voice input device, a touch screen, a storage device, and a processor. The storage device records multiple modules. The processor is coupled to a voice input device, a touch screen, and a storage device and configured to perform the following steps. Historical touch data for multiple historical touch operations performed on the user interface is recorded. Multiple habitual touch areas on the user interface based on the historical touch data of the user interface is determined. When the user interface is displayed through the touch screen, multiple area markers of multiple habitual touch areas are displayed on the user interface. A voice command is received through the voice input device. An input operation is determined based on a first area marker in the voice command, and the input operation is performed on the user interface.

Based on the above, in the embodiments of the disclosure, the historical touch data of multiple historical touch operations performed on the user interface are continuously recorded, and the multiple habitual touch areas of the user interface can be determined based on the historical touch data. Multiple area markers for the habitual touch areas can be displayed on the user interface. By speaking the voice command including the first area marker, the user can control the electronic device to perform the input operation corresponding to the first area marker. Based on the above, the user can control the electronic device through voice to perform various input operations, and the convenience and user experience are significantly improved.

### BRIEF DESCRIPTION OF THE DRAWINGS

FIG. 1 is a block diagram of an electronic device according to an embodiment of the disclosure.

FIG. 2 is a flow chart of a voice control method according to an embodiment of the disclosure.

FIG. 3A is a schematic diagram of historical touch data and habitual touch areas of a user interface according to an embodiment of the disclosure.

FIG. 3B is a schematic diagram of historical touch data and habitual touch areas of a user interface according to an embodiment of the disclosure.

FIG. 4 is a flow chart of determining the habitual touch area according to an embodiment of the disclosure.

FIG. 5 is a schematic diagram of determining the habitual touch area according to an embodiment of the disclosure.

FIG. 6 is a flow chart of displaying multiple area markers according to an embodiment of the disclosure.

FIG. 7 is a schematic diagram of multiple area markers on the user interface according to an embodiment of the disclosure.

FIG. 8 is a flow chart of displaying multiple area markers according to an embodiment of the disclosure.

FIG. 9 is a schematic diagram of multiple area markers on the user interface according to an embodiment of the disclosure.

### DESCRIPTION OF THE EMBODIMENTS

Reference will now be made in detail to exemplary embodiments of the disclosure, examples of which are illustrated in the accompanying drawings. Whenever possible, the same reference numerals are used in the drawings and descriptions to refer to the same or similar parts.

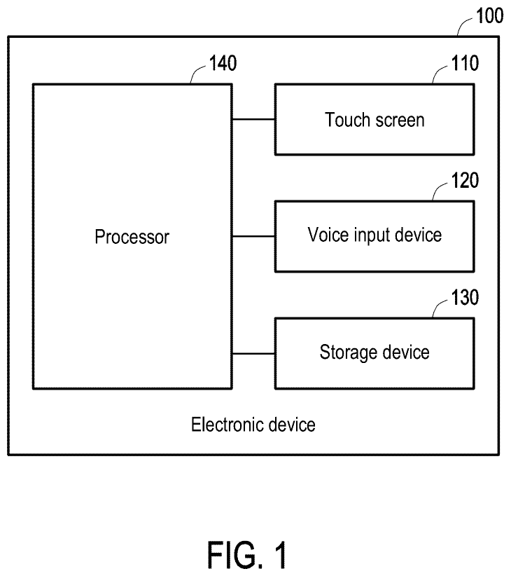

FIG. 1 is a block diagram of an electronic device according to an embodiment of the disclosure Referring to FIG. 1, an electronic device 100 may be implemented as an electronic product having a touch function thereof, such as a notebook computer, a tablet PC, a personal digital assistant (PDA), a smart phone, an e-book, a game console, or a smart wearable devices, and the disclosure is not limited thereto. The electronic device 100 includes a touch screen 110, a voice input device 120, a storage device 130, and a processor 140, whose functions are described as follows.

The touch screen 110 is a display device that integrates touch detection components and can provide both display and input functions. The display device is, for example, a liquid crystal display (LCD), a light-emitting diode (LED) display, a field emission display (FED), or other types of displays, and the disclosure is not limited thereto. The touch screen 110 may be used to display an application program or a user interface of an operating system. The touch detection components are disposed on the display device, and the sensing components are arranged in columns and rows and configured to receive touch operations. The touch operation includes touching the touch screen 110 with fingers, palms, body parts, or other objects. The touch detection component may be, for example, a capacitive touch detection component, a surface acoustic wave touch detection component, an electromagnetic touch detection component, a near-field imaging touch detection component, and the like, and the disclosure is not limited thereto.

The voice input device 120 is used to receive a voice command, which may be various types of microphones, and the disclosure is not limited thereto.

The storage device 130 is used to store data such as files, images, commands, program codes, software modules, which may be, for example, any type of fixed or removable random access memory (RAM), read-only memory (ROM), flash memory, hard disk, or other similar devices, integrated circuits, or a combination thereof.

The processor 140 coupled to the touch screen 110, the voice input device 120, and the storage device 130 is, for example, a central processing unit (CPU), an application processor (AP), or other programmable general-purpose or special-purpose microprocessors, digital signal processors (DSP), or other similar devices, integrated circuits, and combinations thereof. The processor 140 may access and execute commands, software modules, or program codes recorded in the storage device 130 to implement the voice control method according to the embodiments of the disclosure.

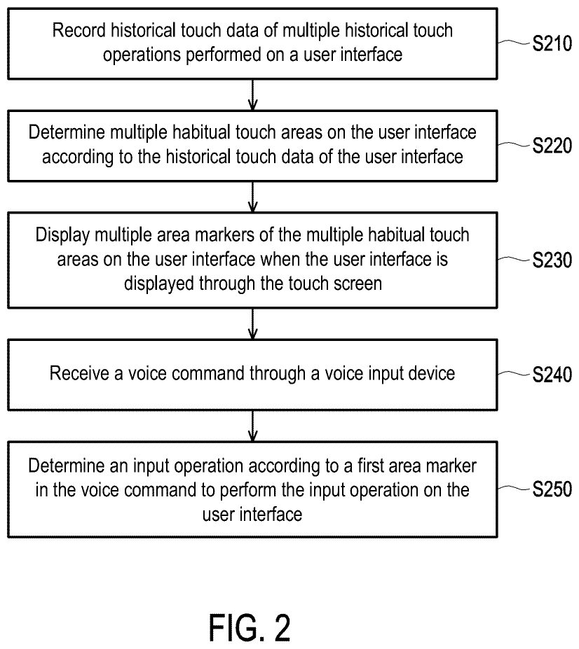

FIG. 2 is a flow chart of a voice control method according to an embodiment of the disclosure, and the flow of the method in FIG. 2 may be applied to the electronic device 100 in FIG. 1. Please refer to FIG. 1 together with FIG. 2. Below, along with various components of the electronic device 100 in FIG. 1, the steps of the voice control method of the embodiment is described.

In Step S210, the processor 140 records historical touch data of multiple historical touch operations performed on the user interface. In some embodiments, the user interface includes a desktop user interface or an application program interface of an application program. The desktop user interface is the user interface of an operation system. The application program is, for example, a game program, a browser program, a multimedia player program, an online shopping program, or a social networking program.

For some embodiments, when the touch screen 110 displays the user interface, the touch screen 110 detects the touch operation performed on the user interface. When the touch screen 110 detects the touch operation performed on the user interface, the touch screen 110 may report one or more touch points of the touch operation to the processor 140, so that the processor 140 may obtain a position and an operation action of the touch operation according to the touch point. The processor 140 may record the position and the operation action of the detected historical touch operation as the historical touch data of the user interface. In other words, the historical touch data may include the position and the operation action of the historical touch operation.

In some embodiments, the position of the touch operation recorded by the processor 140 may include a position of a touch starting point of the touch operation or positions of multiple touch points of the touch operation. The operation actions may include dragging, clicking, multi-clicking, swiping, or other actions.

It should be noted that the interface graphic configurations of different user interfaces are different, and the habitual touch methods of different users are also different. The processor 140 may record the historical touch data of a specific user on a specific user interface, so the processor 140 may obtain historical touch data of the different user interfaces.

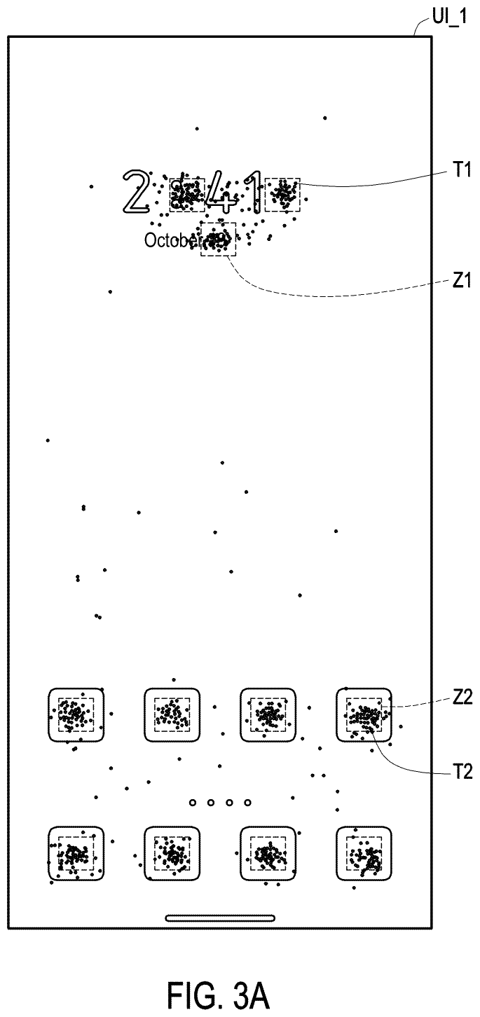

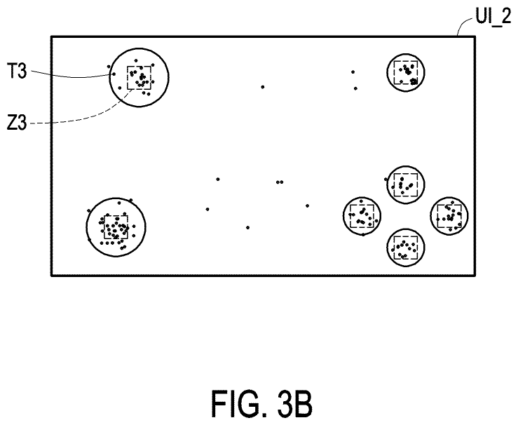

For example, FIG. 3A is a schematic diagram of historical touch data and habitual touch areas of a user interface according to an embodiment of the disclosure. Please refer to FIG. 3A. In some embodiments, a user interface UI_1 may be the desktop user interface of a smartphone. The processor 140 may record the historical touch data of the historical touch operation performed on the user interface UI_1 displayed through the touch screen 110. The processor 140 may record the touch points (such as touch points T1 and T2) of the historical touch operations to the historical touch data of the user interface UI_1. As shown in FIG. 3A, the touch points of the historical touch operations are mostly concentrated on application program icons on the user interface UI_1.

For example, FIG. 3B is a schematic diagram of historical touch data and habitual touch areas of a user interface according to an embodiment of the disclosure. Please refer to FIG. 3B. In some embodiments, a user interface UI_2 may be a game user interface. The processor 140 may record historical touch data of the historical touch operation performed on the user interface UI_2 displayed through the touch screen 110. The processor 140 may record the touch points (such as a touch point T3) of the historical touch operations to the historical touch data of the user interface UI_2. As shown in FIG. 3B, the touch points of the historical touch operations are mostly concentrated on virtual control buttons on the user interface UI_2. In addition, referring to FIG. 3A and FIG. 3B, it may be known that the historical touch data of the user interface UI_1 is different from the historical touch data of the user interface UI_2.

Next, in Step S220, the processor 140 determines multiple habitual touch areas on the user interface according to the historical touch data of the user interface. Specifically, by analyzing the distribution status of the touch points in the historical touch data of the user interface, the processor 140 may determine multiple habitual touch areas on the user interface where the user often issued touch operations in the past.

In some embodiments, the user interface may include a first user interface and a second user interface. For example, the user interface UI_1 and the user interface UI_2 shown in FIG. 3A and FIG. 3B. Alternatively, the first user interface and the second user interface may be application program interfaces of different application programs. The processor 140 may determine multiple first habitual touch areas on the first user interface according to the historical touch data of the first user interface. Moreover, the processor 140 may determine multiple second habitual touch areas on the second user interface according to the historical touch data of the second user interface. The multiple first habitual touch areas are at least partially different from the multiple second habitual touch areas. For example, in the example of FIG. 3A, the processor 140 may determine multiple first habitual touch areas (such as habitual touch areas Z1 and Z2) on the user interface UI_1 according to the historical touch data of the user interface UI_1. In the example of FIG. 3B, the processor 140 may determine multiple second habitual touch areas (such as a habitual touch area Z3) on the user interface UI_2 according to the historical touch data of the user interface UI_2. Since the historical touch data of the user interface UI_1 is different from the historical touch data of the user interface UI_2, positions of the multiple first habitual touch areas of the user interface UI_1 are different from the multiple second habitual touch areas of the user interface UI_2.

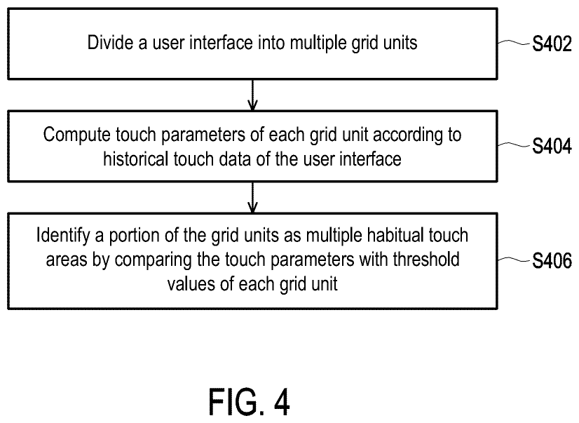

Please refer to FIG. 4, which is a flow chart of determining the habitual touch area according to an embodiment of the disclosure. In some embodiments, Step S220 may be implemented as Steps S402 to S406 in FIG. 4.

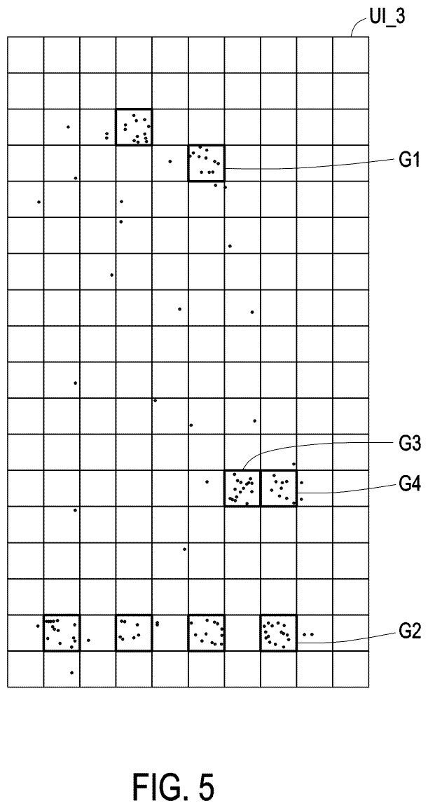

In Step S402, the processor 140 divides the user interface into multiple grid units. Referring to FIG. 5, a user interface UI_3 displayed through the touch screen 110 may be further divided into multiple grid units (for example, grid units G1 to G4). However, the dividing method and the divided quantities are merely examples, persons skilled in the art may make changes according to actual requirements, and the disclosure is not limited thereto.

In Step S404, the processor 140 computes touch parameters of each grid unit according to the historical touch data of the user interface. In different embodiments, the touch parameters of each grid unit include the quantity of touches, the frequency of touches, or the density of touches. According to the quantity of touch points in each grid unit, the processor 140 may calculate the quantity of touches in each grid unit. According to the quantity of touch points in each grid unit within a time period, the processor 140 may calculate the frequency of touches of each grid unit. According to the quantity of touch points and the grid area of each grid unit, the processor 140 may calculate the density of touches in each grid unit.

In Step S406, by comparing the touch parameters with threshold values of each grid unit, the processor 140 identifies a portion of the grid units as multiple habitual touch areas. The processor 140 determines whether the touch parameters of each grid unit is greater than the threshold values. The threshold values may be set according to actual requirements. When the touch parameter of a certain grid unit is greater than the threshold value, the processor 140 may identify the grid unit as the habitual touch area. Otherwise, when the touch parameter of a certain grid unit is not greater than the threshold value, the processor 140 may exclude the grid unit as the habitual touch area. As shown in FIG. 5, since the touch parameters of the grid units G1 and G2 are greater than the threshold values, the processor 140 may identify the grid units G1 and G2 as two habitual touch areas respectively.

In some embodiments, the grid units include multiple adjacent first grid units. The processor 140 may merge multiple adjacent first grid units into one of the multiple habitual touch areas. In detail, when the processor 140 determines that the touch parameters of the multiple adjacent first grid units are greater than the threshold values, the processor 140 may merge the multiple adjacent first grid units into one habitual touch area. That is to say, areas of the habitual touch areas may be the same or different from each other. As shown in FIG. 5, since the touch parameters of the adjacent grid units G3 and G4 are greater than the threshold values, the processor 140 may identify the grid units G3 and G4 as a single habitual touch area.

Afterward, in Step S230, when the user interface is displayed through the touch screen 110, the processor 140 displays multiple area markers of the multiple habitual touch areas on the user interface. The area markers may include texts, numbers, symbols, patterns, or a combination thereof. It should be emphasized that, referring to the above, it may be known that the grid unit whose touch parameter is smaller than the threshold value is not identified as a habitual touch area, and the grid unit whose touch parameter is smaller than the threshold value is not marked with the area marker. In this way, the user interface screen with multiple area markers can be made concise and easy to read.

In addition, in some embodiments, the area markers may be designated number markers for the respective habitual touch areas. Alternatively, in some embodiments, the area markers may be coordinate component markers in different coordinate directions.

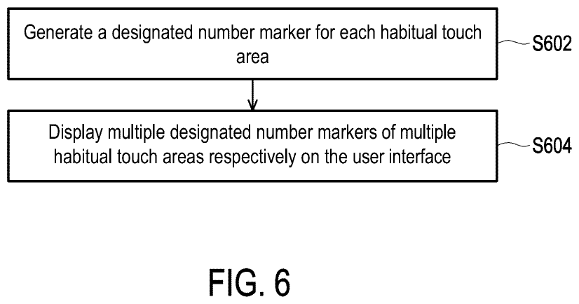

Please refer to FIG. 6, which is a flow chart of displaying multiple area markers according to an embodiment of the disclosure. In some embodiments, Step S230 may be implemented as Steps S602 to S604 in FIG. 6.

In Step S602, the processor 140 generates the designated number marker for each habitual touch area. In detail, in some embodiments, the habitual touch area may correspond to the designated number marker one-to-one. The designated number markers may be multiple numeric markers respectively. In Step S604, the processor 140 displays the multiple designated number markers of the multiple habitual touch areas on the user interface respectively. In different embodiments, the processor 140 may display the designated number marker in the corresponding habitual touch area or next to the corresponding habitual touch area.

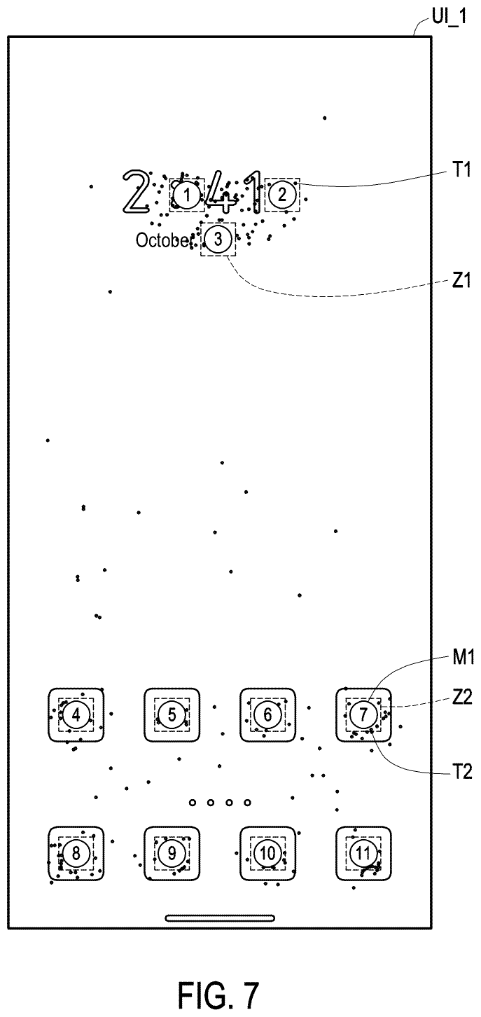

For example, please refer to FIG. 7, which is a schematic diagram of multiple area markers on the user interface according to an embodiment of the disclosure. The processor 140 may determine 11 habitual operation areas according to the historical touch data of the user interface UI_1 and assign designated number markers ‘Number 1’ to ‘Number 11’ to the 11 habitual operation areas respectively. For example, the processor 140 may determine that a designated number marker M1 of the habitual operation area Z2 is ‘Number 7’. In the example of FIG. 7, designated number markers ‘Number 1’ to ‘Number 11’ may be displayed in the respective habitual operation area.

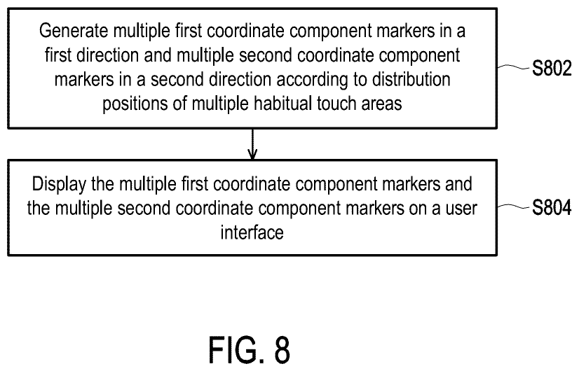

Please refer to FIG. 8, which is a flow chart of displaying multiple area markers according to an embodiment of the disclosure. In some embodiments, Step S230 may be implemented as Steps S802 to S804 in FIG. 8.

In Step S802, the processor 140 generates a plurality of first coordinate component markers in the first direction and a plurality of second coordinate component markers in the second direction according to the distribution positions of the plurality of habitual touch areas. In detail, in some embodiments, each habitual touch area may correspond to one of the plurality of first coordinate component markers and one of the plurality of second coordinate component markers. The first coordinate components may be horizontal coordinate components in the horizontal direction respectively. The second coordinate components may be vertical coordinate components in the vertical direction respectively. In addition, the processor 140 may determine a marked grid area including the habitual touch areas according to the distribution positions of the multiple habitual touch areas and divide the marked grid area into multiple marked grids. Afterward, the processor 140 may mark a plurality of horizontal coordinate components along the horizontal direction of the marked grid and mark a plurality of vertical coordinate components along the vertical direction of the marked grid. In other words, the processor 140 does not divide the entire user interface into the marked grid, but divides a portion of the user interface into the marked grid. Afterward, in Step S804, the processor 140 displays the multiple first coordinate component markers and the multiple second coordinate component markers on the user interface. In some embodiments, for the convenience of user to identify, the processor 140 may simultaneously display the marked grid, the multiple first coordinate component markers, and the multiple second coordinate components on the user interface.

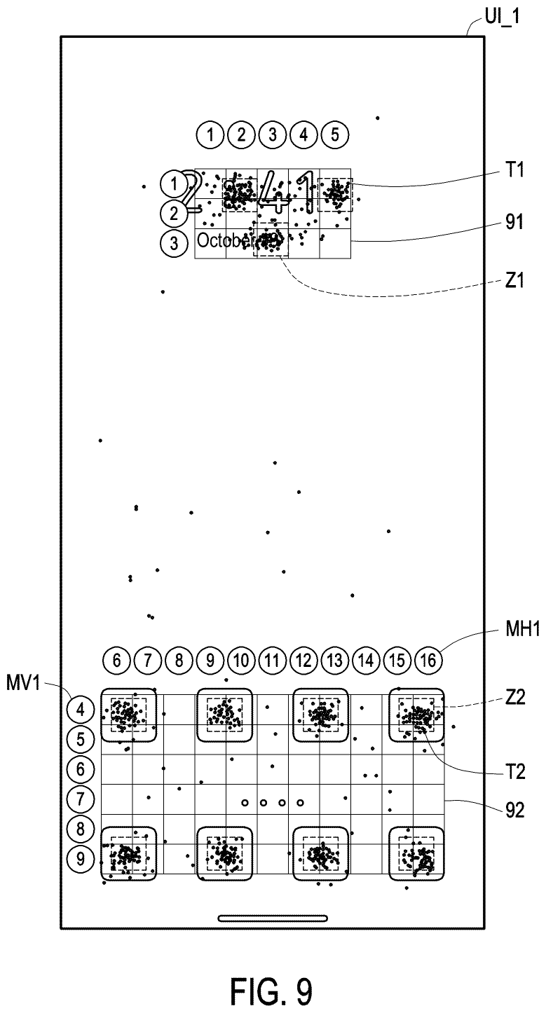

For example, please refer to FIG. 9, which is a schematic diagram of multiple area markers on the user interface according to an embodiment of the disclosure. The processor 140 may determine multiple habitual operation areas according to the historical touch data of the user interface UI_1 and determine marked grid areas 91 and 92 comprising the habitual operation areas. The processor 140 divides the marked grid areas 91 and 92 into multiple marked grids. For example, the processor 140 divides the marked grid area 91 into 5*3 marked grids and divides the marked grid area 92 into 11*6 marked grids. Afterward, the processor 140 may determine the horizontal coordinate components (i.e., the horizontal coordinate components ‘1’ to ‘5’) and the vertical coordinate components (i.e., the vertical coordinate components ‘1’ to ‘3’) of the plurality of marked grids in the marked grid area 91. In the same way, the processor 140 may determine the horizontal coordinate components (i.e., the horizontal coordinate components ‘6’ to ‘16’) and the vertical coordinate components (i.e., the vertical coordinate components ‘4’ to ‘9’) of the multiple marked grids in the marked grid area 92. For example, the processor 140 may determine a vertical coordinate component MV1 to be ‘16’ and determine a horizontal coordinate component MH1 to be ‘16’. Therefore, the processor 140 may display the horizontal coordinate components ‘1’ to ‘16’ and vertical coordinate components ‘1’ to ‘9’ on the user interface UI_1 through the touch screen 110.

In Step S240, the processor 140 receives a voice command through the voice input device 120. In Step S250, the processor 140 determines an input operation according to a first area marker in the voice command and performs the input operation on the user interface. The first area marker is an area marker displayed on the user interface. The processor 140 may perform a voice recognition processing on the voice command and obtain the first area marker spoken by the user. Therefore, the processor 140 may decide to perform the input operation in the habitual touch area corresponding to the first area marker according to the first area marker. For example, the processor 140 can perform the input operation to start the application program corresponding to the habitual touch area. Alternatively, the processor 140 can perform the input operation to drag an interface object from a first position to a second position. Alternatively, the processor 140 can perform the input operation to swipe and browse through a page. Alternatively, the processor 140 can perform the input operation to issue a game control command.

In some embodiments, the processor 140 may perform the voice recognition processing on the voice command and obtain the first area marker and an operation action of the input operation. The input operation includes a clicking operation, a swiping operation, or a dragging operation. For example, taking FIG. 7 as an example, when the user wants to open an application program, the user refers to the multiple designated number markers on the user interface and speaks the voice command “Click Number 7”. Correspondingly, the processor 140 may perform the voice recognition processing on the voice command “Click Number 7” to obtain the first area marker being “Number 7” and the operation action of the input operation being “click”. Therefore, the processor 140 may start the target application program according to the input operation. Alternatively, taking FIG. 9 as an example, when the user wants to open an application program, the user may say the voice command “Click on the horizontal coordinate 16 and the vertical coordinate 4.” Correspondingly, the processor 140 may perform the voice recognition processing on the voice command “Click on the horizontal coordinate 16 and the vertical coordinate 4” to obtain the first coordinate component being “16”, the second coordinate component being “4”, and the operation action of the input operation being “Click”. Therefore, the processor 140 may start the target application program corresponding to the first coordinate component “16” and the second coordinate component “4” according to the input operation.

In summary, in the embodiment of the disclosure, multiple habitual touch areas of the user interface can be determined based on the historical touch data. Multiple area markers for the habitual touch areas can be displayed on the user interface. By speaking the voice command including the first area marker, the user can control the electronic device to perform the input operation corresponding to the first area marker. Based on the above, the user can control the electronic device through voice to perform various input operations, and the convenience and user experience are significantly improved. In addition, marking can be done on the habitual touch area rather than on the entire user interface, so that the area markers are concise and easy to read.

Finally, it should be noted that, the above embodiments are merely used to illustrate the technical solution of the disclosure, rather than to limit the disclosure. Although the disclosure has been described in detail with the embodiments, it should be understood that persons of ordinary skill in the art may still modify the technical solutions recorded in the embodiments or make equivalent substitutions for some or all of the technical features. However, the modifications or substitutions do not cause the essence of the corresponding technical solution to deviate from the scope of each technical solution according to the embodiments of the disclosure.

What is claimed is:

1. A voice control method adapted to an electronic device comprising a touch screen and a voice input device, comprising:
recording historical touch data of a plurality of historical touch operations performed on a user interface;
determining a plurality of habitual touch areas on the user interface according to the historical touch data of the user interface;
in response to the user interface being displayed through the touch screen, displaying a plurality of area markers of the plurality of habitual touch areas on the user interface;
receiving a voice command through the voice input device; and
determining an input operation according to a first area marker in the voice command to perform the input operation on the user interface.

2. The voice control method as claimed in claim 1, wherein the user interface comprises a desktop user interface or an application program interface of an application program.

3. The voice control method as claimed in claim 1, wherein the user interface comprises a first user interface and a second user interface, and determining the plurality of habitual touch areas on the user interface according to the historical touch data of the user interface comprises:
determining a plurality of first habitual touch areas on the first user interface according to the historical touch data of the first user interface; and
determining a plurality of second habitual touch areas on the second user interface according to the historical touch data of the second user interface, wherein the plurality of first habitual touch areas are at least partially different from the plurality of second habitual touch areas.

4. The voice control method as claimed in claim 1, wherein in response to the user interface being displayed through the touch screen, displaying the plurality of area markers of the plurality of habitual touch areas on the user interface comprises:
generating a designated number marker for each of the plurality of habitual touch areas; and
displaying a plurality of designated number markers of the plurality of habitual touch areas respectively on the user interface.

5. The voice control method as claimed in claim 1, wherein in response to the user interface being displayed through the touch screen, displaying the plurality of area markers of the plurality of habitual touch areas on the user interface according to positions of the plurality of habitual touch areas comprises:
generating a plurality of first coordinate component markers in a first direction and a plurality of second coordinate component markers in a second direction according to distribution positions of the plurality of habitual touch areas; and
displaying the plurality of first coordinate component markers and the plurality of second coordinate component markers on the user interface.

6. The voice control method as claimed in claim 1, wherein determining the plurality of habitual touch areas on the user interface according to the historical touch data of the user interface comprises:
dividing the user interface into a plurality of grid units;
computing touch parameters of each of the plurality of grid units according to the historical touch data of the user interface; and
identifying a portion of the grid units as the plurality of habitual touch areas by comparing the touch parameters with threshold values of each of the grid units.

7. The voice control method as claimed in claim 6, wherein the plurality of grid units comprise a plurality of adjacent first grid units, and identifying the portion of the grid units as the plurality of habitual touch areas by comparing the touch parameters with threshold values of each of the grid units further comprises:
merging the plurality of adjacent first grid units into one of the plurality of habitual touch areas.

8. The voice control method as claimed in claim 6, wherein the touch parameters of each of the grid unit comprise a quantity of touches, a frequency of touches, or a density of touches.

9. The voice control method as claimed in claim 1, further comprising:
performing a voice recognition processing on the voice command and obtaining the first area marker and an operation action of the input operation.

10. The voice control method as claimed in claim 1, wherein the input operation comprises a clicking operation, a swiping operation, or a dragging operation.

11. An electronic device, comprising:
a voice input device;
a touch screen;
a storage device recorded with a plurality of modules; and
a processor coupled to the voice input device, the touch screen, and the storage device and configured to:
record historical touch data of a plurality of historical touch operations performed on a user interface;
determine a plurality of habitual touch areas on the user interface according to the historical touch data of the user interface;
in response to the user interface being displayed through the touch screen, display a plurality of area markers of the plurality of habitual touch areas on the user interface;
receive a voice command through the voice input device; and
determine an input operation according to a first area marker in the voice command to perform the input operation on the user interface.

12. The electronic device as claimed in claim 11, wherein the user interface comprises a desktop user interface or an application program interface of an application program.

13. The electronic device as claimed in claim 11, wherein the user interface comprises a first user interface and a second user interface, and the processor is configured to:
determine a plurality of first habitual touch areas on the first user interface according to the historical touch data of the first user interface; and
determine a plurality of second habitual touch areas on the second user interface according to the historical touch data of the second user interface, wherein the plurality of first habitual touch areas are at least partially different from the plurality of second habitual touch areas.

14. The electronic device as claimed in claim 11, wherein the processor is configured to:
generate a designated number marker for each of the plurality of habitual touch areas; and
display a plurality of designated number markers of the plurality of habitual touch areas respectively on the user interface.

15. The electronic device as claimed in claim 11, wherein the processor is configured to:
generate a plurality of first coordinate component markers in a first direction and a plurality of second coordinate component markers in a second direction according to distribution positions of the plurality of habitual touch areas; and
display the plurality of first coordinate component markers and the plurality of second coordinate component markers on the user interface.

16. The electronic device as claimed in claim 11, wherein the processor is configured to:
divide the user interface into a plurality of grid units;
compute touch parameters of each of the plurality of grid units according to the historical touch data of the user interface; and
identify a portion of the grid units as the plurality of habitual touch areas by comparing the touch parameters with threshold values of each of the grid units.

17. The electronic device as claimed in claim 16, wherein the plurality of grid units comprise a plurality of adjacent first grid units, and the processor is configured to:
merge the plurality of adjacent first grid units into one of the plurality of habitual touch areas.

18. The electronic device as claimed in claim 16, wherein the touch parameters of each of the grid units comprise a quantity of touches, a frequency of touches, or a density of touches.

19. The electronic device as claimed in claim 11, wherein the processor is configured to:
perform a voice recognition processing on the voice command and obtain the first area marker and an operation action of the input operation.

20. The electronic device as claimed in claim 11, wherein the input operation comprises clicking operation, a swiping operation, or a dragging operation.
